(19) United States
(12) Patent Application Publication
(10) Pub. No.: US 2022/0053252 A1
(43) Pub. Date: Feb. 17, 2022

(54) AUDIO REPRODUCTION DEVICE

(71) Applicant: SONY GROUP CORPORATION, TOKYO (JP)

(72) Inventors: TAKAYUKI NEGISHI, TOKYO (JP); JUN KOMIYAMA, KANAGAWA (JP)

(21) Appl. No.: 17/309,782

(22) PCT Filed: Nov. 20, 2019
(86) PCT No.: PCT/JP2019/045378

§ 371 Date: Jun. 17, 2021

(30) Foreign Application Priority Data
Dec. 27, 2018 (JP) 2018-244036

(51) Int. Cl. H04R 1/02; H04R 3/00

(52) U.S. Cl. CPC H04R 1/026; H04R 1/028; H04R 3/00

(57) ABSTRACT

Provided is an audio reproduction device including: first and second speaker supports that have a lid shape and are provided on a case in an openable and closable manner; a sensor that detects a first state and a second state, the first and second speaker supports being closed in the first state, the first and second speaker supports being opened and held almost horizontally in the second state; first and second speakers respectively attached on front surfaces of the first and second speaker supports such that a distance in the second state is larger than a distance in the first state; and a reproduction characteristic control unit that switches reproduction characteristics of the first and second speakers in the first state and the second state on the basis of a detection signal from the sensor.

### TECHNICAL FIELD

The present technology relates to an audio reproduction device in which a plurality of speakers is attached to a case.

### BACKGROUND ART

In order to perform audio reproduction, audio reproduction devices, in which a plurality of speakers is integrated for convenience of carriage, are used to enjoy music outdoors. For example, Patent Document 1 discloses configuration in which an operation unit and a display unit are provided on the front surface portion of a box-shaped acoustic device body, a speaker is arranged on the side of the upper surface portion thereof, and an opening/closing lid is provided. The operation unit and the display unit are used to select an operation mode of the acoustic device. The opening/closing lid closes the speaker. Furthermore, a detection element that turns on and off in response to the opening/closing of the above-described opening/closing lid is provided on the acoustic device body. The lid opened state of the above-described opening/closing lid is controlled on the basis of output from a main control unit provided on the above-described acoustic device body. The opening/closing lid has a function as a dustproof acoustic reflection plate.

In the case described in Patent Document 1, a speaker is not attached on a lid. In the lid closed state, a lid completely covers the front surface of the speaker. Thus, good audio reproduction is difficult to be performed.

Furthermore, Patent Document 2 discloses a sound control device including an angle detection unit and a correction unit. The angle detection unit detects an opening angle of a horn unit capable of adjusting a sound directivity angle. The correction unit corrects a sound volume and frequency characteristics in response to changes of the opening angle detected by the angle detection unit.

### CITATION LIST

### Patent Document

Patent Document 1: Japanese Patent Application Laid-Open No. 2001-339785
Patent Document 2: Japanese Patent Application Laid-Open No. 2004-086757

### SUMMARY OF THE INVENTION

### Problems to be Solved by the Invention

The sound control device in Patent Document 2 is applied to a horn speaker system including an angle change adapter horn, and does not control the reproduction characteristics in response to changes in position of a speaker.

Consequently, an object of the present technology is to provide an audio reproduction device in which a speaker is attached on a lid-shaped speaker support and good audio reproduction can be performed in both the closed state and the opened state of the speaker support.

### Solutions to Problems

The present technology relates to an audio reproduction device including:

first and second speaker supports that have a lid shape and are provided on a case in an openable and closable manner;

a sensor that detects a first state and a second state, the first and second speaker supports being closed in the first state, the first and second speaker supports being opened and held almost horizontally in the second state;

first and second speakers respectively attached on front surfaces of the first and second speaker supports such that a distance in the second state is larger than a distance in the first state; and

a reproduction characteristic control unit that switches reproduction characteristics of the first and second speakers in the first state and the second state on the basis of a detection signal from the sensor.

### Effects of the Invention

According to at least one embodiment, the present technology can perform audio reproduction in both the closed state and the opened state of a speaker support, and good audio reproduction can be performed by switching reproduction characteristics in accordance with the states. Note that the effects described here are not necessarily limited, and any of the effects described in the present technology or effects different therefrom may be exhibited.

### BRIEF DESCRIPTION OF DRAWINGS

FIG. 1 is a block diagram illustrating the system configuration of one embodiment of the present technology.

FIG. 2 is a perspective view of the appearance in the state in which a speaker support of one embodiment is closed.

FIG. 3 is a perspective view of the appearance in the state in which the speaker support of one embodiment is opened.

FIG. 4 is a partial perspective view of one embodiment.

FIG. 5 includes a perspective view and a partial perspective view for illustrating a locking mechanism of the speaker support.

FIG. 6 is a partial perspective view used to illustrate a sensor for detecting the opened/closed state of the speaker support.

FIG. 7 is a perspective view for illustrating a used state of one embodiment.

### MODE FOR CARRYING OUT THE INVENTION

Hereinafter, an embodiment and the like of the present technology will be described with reference to the drawings. Note that the embodiment and the like described below are preferred specific examples of the present technology, and the contents of the present technology are not limited to the embodiment and the like. Furthermore, in the following description, in order to prevent the illustration from being complicated, a reference sign may be attached to only some of configurations, or some configurations may be illustrated while being simplified.

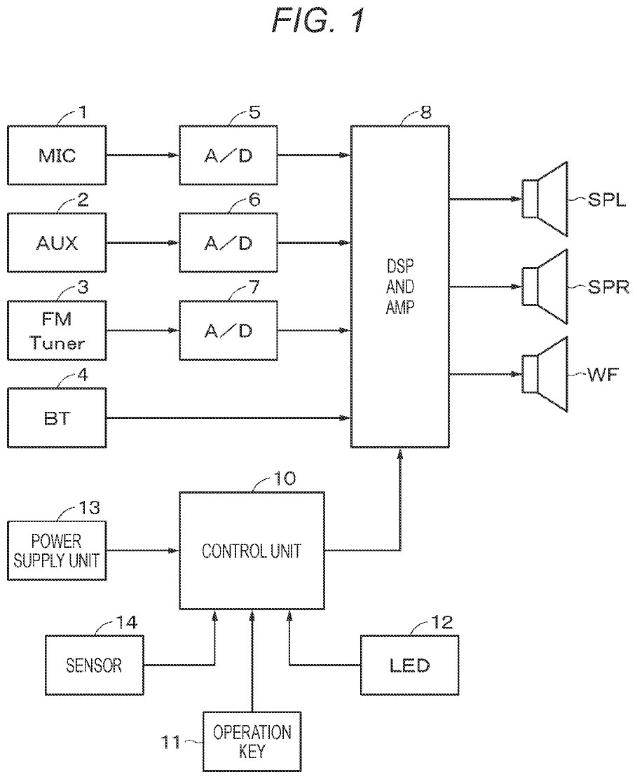

The entire system configuration of one embodiment of the present technology will be described with reference to FIG. 1. For example, a microphone input 1, an external analog input 2, output of an FM tuner 3, audio data 4 by wireless transmission such as Bluetooth (registered trademark) are used as an input signal. In addition, input of data stored in a memory such as a flash memory may be possible.

The outputs of the microphone input 1, the external analog input 2, and the FM tuner 3 are converted into digital signals via A/D converters 5, 6 and 7, respectively, and supplied to a digital signal processor (DSP) and an amplifier unit 8. The audio data 4 by wireless transmission is also supplied to the DSP and the amplifier unit 8. The DSP and the amplifier unit 8 have functions of performing signal processing for surround effects and of an amplifier that amplifies an output audio signal and supplies the signal to tweeters SPL and SPR and a woofer WF.

The tweeter SPL on the left side, the tweeter SPR on the right side, and the woofer WF are connected to the DSP and the amplifier unit 8. The tweeters SPL and SPR reproduce a high-range audio signal, and the woofer WF is a speaker for reproducing mid-low pitch sound. The DSP and the amplifier unit 8 perform signal processing for 2.1ch surround. The 2.1ch surround can create spatially expansive surround effects.

A control unit 10 that controls the entire audio reproduction device is provided. The control unit 10 includes, for example, a central processing unit (CPU), a random access memory (RAM), and a read only memory (ROM). A signal from an operation unit 11 such as an operation key is supplied to the control unit 10. The control unit 10 controls the display of a light emitting diode (LED) 12. Moreover, a power supply unit 13 is provided, and power is supplied to each unit. A power supply circuit that generates a DC power supply from a commercial power supply is provided in the power supply unit 13. The power supply unit 13 includes a built-in secondary battery. The control unit 10 controls the charge/discharge of the secondary battery.

Moreover, in one embodiment, as will be described later, a tweeter support serving as a lid-shaped speaker support is provided on an upper part of a case in an openable and closable manner, and a sensor 14 that detects the opening and closing of the speaker support is provided. One example of the sensor 14 is a Hall IC. The Hall IC includes a Hall element. The Hall IC uses a Hall voltage generated by the Hall element at the time when a magnet approaches the Hall element as detection output. For example, in a closed state (referred to as a first state as appropriate) in which a lid is closed, a detection voltage is generated. In an opened state (referred to as a second state as appropriate) in which the lid is opened, the detection voltage is not generated. The detection voltage of the sensor 14 is supplied to the control unit 10. Note that, for example, an optical sensor may be used as the sensor 14 in addition to a magnetic sensor such as the Hall IC.

The control unit 10 forms a control signal for the DSP and the amplifier unit 8 by the detection output of the sensor 14. In one example, the control unit 10 supplies a control signal for performing control of switching the reproduction characteristics as illustrated in Table 1 below to the DSP and the amplifier unit 8.

TABLE 1

| | | First state | Second state |
|---|---|---|---|
| | | (closed) | (opened) |
| Filter cutoff | Woofer WF | 2.8 kHz | 2.5 kHz |
| frequency | Tweeter | 4.5 kHz | 2.1 kHz |
| | SPL/SPR | | |

| | | |
|---|---|---|
| Surround processing | Off | On |

As illustrated in Table 1, in the first state, a filter cutoff frequency applied to a signal for the woofer WF is set at 2.8 kHz, and a filter cutoff frequency applied to a signal for the tweeters SPL and SPR is set at 4.5 kHz. Furthermore, surround processing is not performed.

In the second state, the filter cutoff frequency applied to a signal for the woofer WF is set at 2.5 kHz, and the filter cutoff frequency applied to a signal for the tweeters SPL and SPR is set at 2.1 kHz. Furthermore, surround processing is performed. Note that, in a case where the reproduction characteristics are switched between the first state and the second state, not only frequency characteristics but a signal level may be controlled. The reproduction band, a crossover frequency, a reproduction signal level, a phase of a reproduction signal, on/off of surround processing, and the like are referred to as the reproduction characteristics.

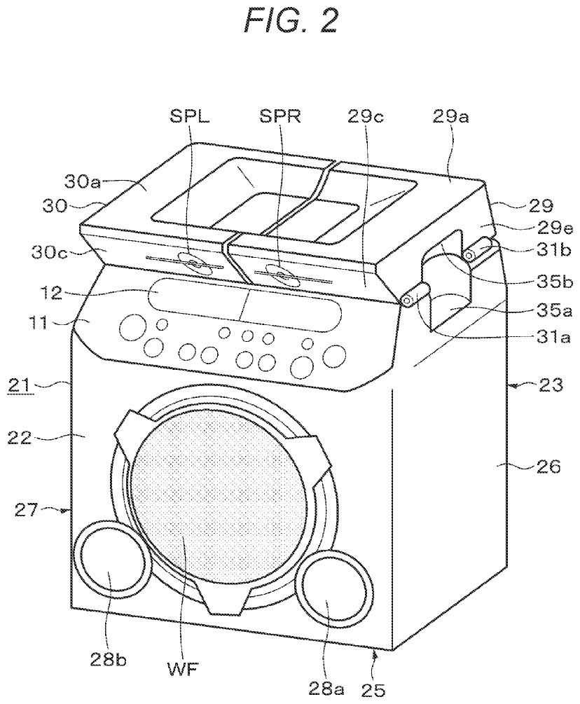

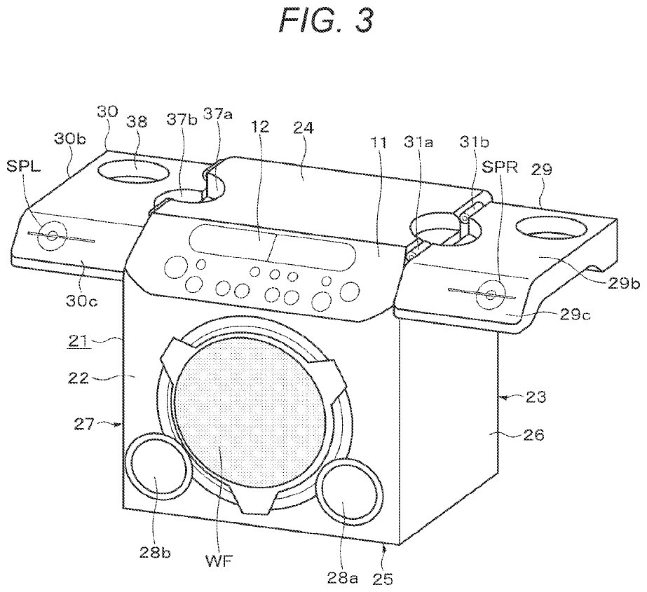

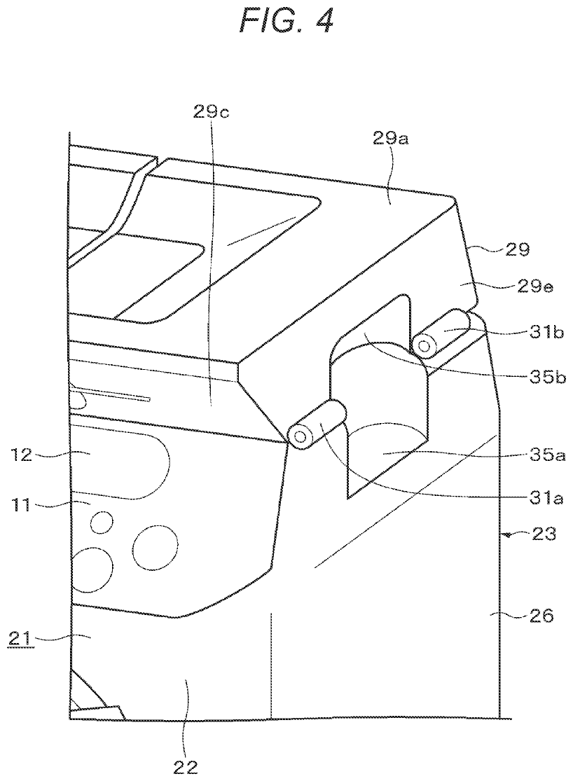

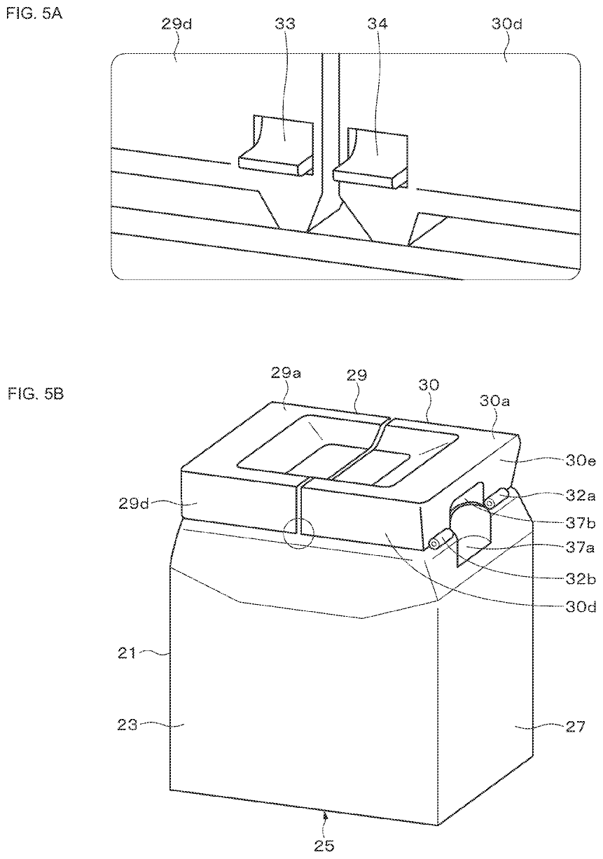

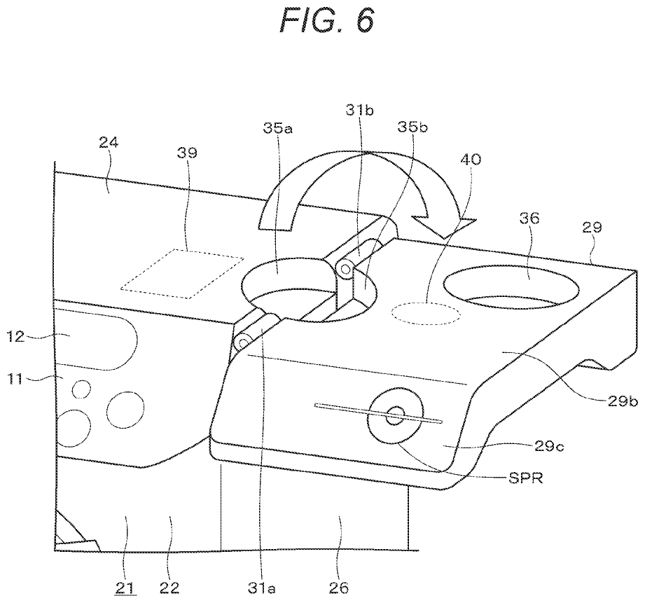

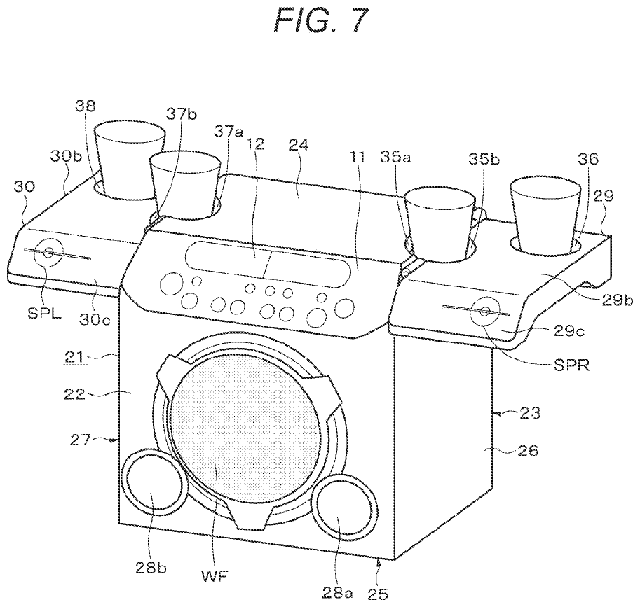

FIG. 2 is a perspective view of the appearance in the state (referred to as the first state as appropriate) in which a lid-shaped tweeter support of one embodiment is closed. FIG. 3 is a perspective view of the appearance in the state (referred to as the second state as appropriate) in which the tweeter support of one embodiment is opened. FIG. 4 is a partial perspective view of one embodiment. FIG. 5 includes a perspective view and a partial perspective view for illustrating a locking mechanism of the tweeter support. FIG. 6 is a partial perspective view used to illustrate a sensor for detecting the opened/closed state of the tweeter support. FIG. 7 is a perspective view for illustrating a used state of one embodiment.

A case 21 has a shape of a box having a front surface 22, a back surface 23, an upper surface 24, a bottom surface 25, a right side surface 26, and a left side surface 27. The case 21 is, for example, a molded product of synthetic resin. The woofer WF is attached on the front surface 22. Bass reflex ducts 28a and 28b are formed on both sides of the woofer WF. The woofer WF is, for example, a cone type speaker.

An inclined surface is formed between an upper portion of the front surface 22 and the upper surface 24 of the case 21, and the operation unit 11 and the LED 12 are installed on the inclined surface. A wiring board is provided inside the case 21. Electric configurations of a system in FIG. 1 are mounted on the wiring board. The wiring board is installed inside the upper surface 24 of the case 21, for example.

Tweeter supports 29 and 30 serving as lid-shaped speaker supports are rotatably attached on the upper surface 24 of the case 21. The tweeter supports 29 and 30 are provided bisymmetrically. The tweeter support 29 is the size of the right half of the upper surface 24 of the case 21, and has facing main surfaces 29a and 29b, a front surface 29c, a back surface 29d, and both side surfaces. The tweeter SPR is attached on the front surface 29c of the tweeter support 29. In the first state, the tweeter SPR is attached slightly inside from the center of the front surface 29c. In the first state, since the tweeter supports 29 and 30 are housed within the width of the case 21, the audio reproduction device can be easily handled during, for example, transportation and storage.

The tweeter support 30 has a shape similar to that of the tweeter support 29. That is, the tweeter support 30 is the size of the left half of the upper surface 24 of the case 21, and has facing main surfaces 30a and 30b, a front surface 30c, a back surface 30d, and both side surfaces. The tweeter SPL is attached on the front surface 30c of the tweeter support 30. In the first state, the tweeter SPL is attached slightly inside from the center of the front surface 30c. The tweeters SPR and SPL have, for example, a cone type configuration, and include a protective ring on the front surface.

As illustrated in an enlarged manner in FIG. 4, hinges 31a and 31b couple the case 21 and one side surface 29e of the tweeter support 29, which allows the tweeter support 29 to rotate clockwise as seen from the front surface. If the tweeter support 29 is rotated by a hand, the side surface 29e of the tweeter support 29 hits the right side surface 26 of the case 21, and the first state transitions to the second state in which the tweeter support 29 is almost horizontally held on the right side of the case 21.

Hinges 32a and 32b couple the case 21 and one side surface 30e of the tweeter support 30, which allows the tweeter support 30 to rotate counterclockwise as seen from the front surface. If the tweeter support 30 is rotated by a hand, the side surface 30e of the tweeter support 30 hits the left side surface 27 of the case 21, and the first state transitions to the second state in which the tweeter support 30 is almost horizontally held on the left side of the case 21.

In one embodiment, music can be reproduced both in the first state and the second state. In the first state, the tweeter supports 29 and 30 are placed on the upper surface 24 of the case 21. In the second state, the tweeter supports 29 and 30 are rotated and almost horizontally supported on both sides of the case 21. Since the distance between the tweeters SPL and SPR at the time when music is reproduced in the second state is larger than that at the time when music is reproduced in the first state, music can be expansively reproduced. The respective front surfaces 29c and 30c of the tweeter supports 29 and 30 are inclined upward so that sound of the tweeters SPL and SPR can be radiated diagonally upward in the second state.

As illustrated in FIG. 5(b), locking claws 33 and 34 as illustrated in FIG. 5(a) are provided on the back surface 29d of the tweeter support 29 and the back surface 30d of the tweeter support 30. In a case where the claws 33 and 34 are not lifted, the tweeter supports 29 and 30 are locked so as to be held in the first state. In a case where the claws 33 and 34 are lifted, the lock is released, and the tweeter supports 29 and 30 can be rotated from the first state to the second state.

As illustrated in an enlarged manner in FIG. 4, a cut portion 35a is provided near the center (position between the hinges 31a and 31b) of the joint where an end of the upper surface 24 of the case 21 and an end of the right side surface 26 are in contact with each other. The cut portion 35a has a semi-cylindrical shape facing inward from the right side surface 26. A semi-cylindrical cut portion 35b of similar size is formed at the position of the tweeter support 29 corresponding to the cut portion 35a. The cut portions 35a and 35b form a recess in the first state, and a finger can be put on the recess at the time when the reproduction device is transported.

These cut portions 35a and 35b form a cylindrical recess in a case where the tweeter support 29 is opened to the second state. The recess can be used as a cup holder, as illustrated in FIG. 7. A recess 36 having a circular opening is formed on the main surface 29b of the tweeter support 29 to be exposed in the second state. The recess 36 can also be used as a cup holder, as illustrated in FIG. 7. Note that these recesses can be used as a holding portion or a placing portion for an article other than a cup as long as the size fits.

A cut portion 37a is provided near the center (position between the hinges 32a and 32b) of the joint where an end of the upper surface 24 of the case 21 and an end of the left side surface 27 are in contact with each other. The cut portion 37a has a semi-cylindrical shape facing inward from the left side surface 27. A semi-cylindrical cut portion 37b of similar size is formed at the position of the tweeter support 30 corresponding to the cut portion 37a. The cut portions 37a and 37b form a recess in the first state, and a finger can be put on the recess at the time when the reproduction device is transported.

These cut portions 37a and 37b form a cylindrical recess in a case where the tweeter support 30 is opened to the second state. The recess can be used as a cup holder, as illustrated in FIG. 7. A recess 38 having a circular opening is formed on the main surface 30b of the tweeter support 30 to be exposed in the second state. The recess 38 can also be used as a cup holder, as illustrated in FIG. 7.

Note that, in FIG. 6, as illustrated by two-dot chain lines, a Hall element 39 is arranged on the back side of the upper surface 24 of the case 21, and a magnet 40 is provided at a position that approaches the Hall element 39 at the time when the tweeter support 29 is closed on the back side of the main surface 29b of the tweeter support 29. In the first state in which the tweeter support 29 is closed, a detection voltage is generated from the Hall element 39, and the control unit can detect the first state. In the second state in which the tweeter support 29 is opened, the detection voltage is not generated, and the control unit can detect the second state. In a manner similar to that of the tweeter support 29, a magnet is provided on the tweeter support 30, and the control unit can detect the opening/closing of the tweeter support 30. In a case where the control unit detects a state in which both the tweeter supports 29 and 30 are closed, the control unit defines the state as the first state. In a case where the control unit detects a state in which both the tweeter supports 29 and 30 are opened, the control unit defines the state as the second state.

Although the embodiment of the present technology has been specifically described above, the above-described embodiment is not a limitation. Various variations based on the technical idea of the present technology are possible. For example, configurations of not 2.1ch but 3.1ch and the like may be adopted. For example, the upper three speakers may be arranged side by side. The left and right speakers may be attached on a lid-shaped support. The central speaker may be fixed. Moreover, a speaker of types other than the cone type can be used.

The configurations, methods, processes, shapes, materials, numerical values, and the like mentioned in the above-described embodiment are merely examples, and different configurations, methods, processes, shapes, materials, numerical values, and the like may be used as necessary. The above-described embodiment and variations can be combined as appropriate.

The present technology can also adopt the following configurations.

(1)

An audio reproduction device including:

first and second speaker supports that have a lid shape and are provided on a case in an openable and closable manner;

a sensor that detects a first state and a second state, the first and second speaker supports being closed in the first state, the first and second speaker supports being opened and held almost horizontally in the second state;

first and second speakers respectively attached on front surfaces of the first and second speaker supports such that a distance in the second state is larger than a distance in the first state; and

a reproduction characteristic control unit that switches reproduction characteristics of the first and second speakers in the first state and the second state on the basis of a detection signal from the sensor.

(2)

The audio reproduction device according to (1),

in which the first and second speakers are tweeters, and

a woofer is provided on the case on a lower side of the speaker support.

(3)

The audio reproduction device according to (1) or (2),

in which the reproduction characteristic control unit switches reproduction characteristics such that surround processing is turned off in the first state and the surround processing is turned on in the second state.

(4)

The audio reproduction device according to any one of (1) to (3),

in which the speaker support is provided on an upper surface of the audio reproduction device,

the first and second speakers are attached on front surfaces of the first and second speaker supports, and

the front surfaces are inclined so that radiation directions of the first and second speakers are set obliquely upward in the second state.

(5)

The audio reproduction device according to any one of (1) to (4), including

a locking mechanism that holds the first state of the first and second speaker supports.

(6)

The audio reproduction device according to any one of (1) to (5),

in which first and second cut portions are respectively formed at a joint between a side surface and an upper surface of the case and a corresponding position on a side surface of the first and second speaker supports,

the first and second cut portions form a recess in the first state, and

the first and second cut portions form a recess usable as a holding portion or a placing portion for an article in the second state.

(7)

The audio reproduction device according to any one of (1) to (6),

in which another recess usable as a holding portion or a placing portion for an article is formed on main surfaces of the first and second speaker supports, which are exposed in the second state.

### REFERENCE SIGNS LIST

SPL, SPR Tweeter
WF Woofer
8 DSP and Amplifier unit
10 Control unit
21 Case
29, 30 Speaker support
31a, 31b, 32a, 32b Hinge

1. An audio reproduction device comprising:
first and second speaker supports that have a lid shape and are provided on a case in an openable and closable manner;
a sensor that detects a first state and a second state, the first and second speaker supports being closed in the first state, the first and second speaker supports being opened and held almost horizontally in the second state;
first and second speakers respectively attached on front surfaces of the first and second speaker supports such that a distance in the second state is larger than a distance in the first state; and
a reproduction characteristic control unit that switches reproduction characteristics of the first and second speakers in the first state and the second state on a basis of a detection signal from the sensor.

2. The audio reproduction device according to claim 1,
wherein the first and second speakers are tweeters, and
a woofer is provided on the case on a lower side of the speaker support.

3. The audio reproduction device according to claim 1,
wherein the reproduction characteristic control unit switches reproduction characteristics such that surround processing is turned off in the first state and the surround processing is turned on in the second state.

4. The audio reproduction device according to claim 1,
wherein the speaker support is provided on an upper surface of the audio reproduction device,
the first and second speakers are attached on front surfaces of the first and second speaker supports, and
the front surfaces are inclined so that radiation directions of the first and second speakers are set obliquely upward in the second state.

5. The audio reproduction device according to claim 1, comprising
a locking mechanism that holds the first state of the first and second speaker supports.

6. The audio reproduction device according to claim 1,
wherein first and second cut portions are respectively formed at a joint between a side surface and an upper surface of the case and a corresponding position on a side surface of the first and second speaker supports,
the first and second cut portions form a recess in the first state, and
the first and second cut portions form a recess usable as a holding portion or a placing portion for an article in the second state.

7. The audio reproduction device according to claim 1,
wherein another recess usable as a holding portion or a placing portion for an article is formed on main surfaces of the first and second speaker supports, which are exposed in the second state.
